(19) United States
(12) Patent Application Publication
(10) Pub. No.: US 2026/0165260 A1
(43) Pub. Date: Jun. 18, 2026

(54) Dynamically Positionable Planter

(71) Applicant: Jordan Bichrest, Harpswell, ME (US)

(72) Inventor: Jordan Bichrest, Harpswell, ME (US)

(21) Appl. No.: 19/369,521

(22) Filed: Oct. 27, 2025

Related U.S. Application Data
(63) Continuation-in-part of application No. 18/441,423, filed on Feb. 14, 2024, now Pat. No. 12,464,987.

(51) Int. Cl. A01G 9/28

(52) U.S. Cl. CPC A01G 9/28

(57) ABSTRACT

A plant holder that is configured to hold multiple plant pots and that is rotatable so that the pots may be positioned on either side of the planter or positioned in a flat work-table like manner

### BACKGROUND INFORMATION

### Field of the Invention

The invention relates to plant pot holders, plant stands, and gardening tables.

### Discussion Of Prior Art

There are many known benefits from growing, having, and being around various forms of plants. Fruits and vegetables, of course, have many nutritional benefits, while non-edible plants have numerous benefits from being aesthetically pleasing to potentially even reducing stress and increasing productivity.

While many plants need little more than soil, water, and light in order to grow, that growth is often hindered if the plant does not get enough light or space to grow. And this often poses a greater challenge when growing a number of plants in pots as the various pots may block one another and cause plants to compete for sunlight. For example, it is common to have number of plants on a gardening table or similar work surface. This is helpful as it may be ergonomic for the grower, however, as certain plants grow, they may limit access to light for other plants on the table. Similarly, if a number of platforms are layered or stacked on top of one another this may also limit growth.

Another complication may arise in indoor situations where, if the plants are positioned towards the window they may not be as visible to the inside of the room where they are most visible to the inhabitants, or alternatively the plants may not have proper access to sunlight if they are positioned away from windows and towards the inside of the room. A staggered arrangement is also difficult to work, whereas a flat table-like arraignment does not provide ideal light and/or viewing of the plants.

What is needed, therefore, is a planter that allows multiple plants to be placed in multiple positions to separately allow the plants to obtain the necessary access to light, allow a grower to have convenient access to the plants, and present the plants to an interior of the room.

### BRIEF SUMMARY OF THE INVENTION

The invention is a rotatable plant holder that holds multiple pots and that may alternatively be positioned in a staggered arrangement to allow multiple rows of pots to have equal access to light, to lay flat in a work-table like arrangement, and to be staggered in multiple orientations to allow the best access to light and/or present the plants in the best viewing position.

The plant holder includes a base frame and a planter frame, with the planter frame configured to hold a number of planter trays that may be configured in a number of ways to hold pots of various shapes and sizes. The configuration of the base frame may vary depending on the area of the intended use of the device, and in particular, whether the device is to be used inside a building or outside. More specifically, when the device is intended to be used inside, it is likely to have a narrow base so that it may be positioned close to a window for ideal light as well as to take up less floor space, and such a design may include a base that is somewhat off-center relative to the planter frame and require a counterweight to keep it in the proper position. On the other hand, a device that is intended to be used outside likely does not have such limitations and as such, the base may be wider and be equally spaced on either side of the planter frame.

The planter frame is rotatably supported in the base frame such that it may move 360 degrees in the vertical plane. The planter trays are coupled to the planter frame by swivel rods that enable the trays to maintain an upright position as the planter frame rotates relative to the base frame. The planter trays are also balanced to further assist in maintaining an upright position as the planter frame is rotated within the base frame.

As such, the planter frame may be angled towards a window, for example with a 30-45-degree angle, and each plant in each of the trays would have full access to the light. The planter frame may also be laid flat at 90 degrees in which case the planter frame and planter trays resemble a form of gardening table.

Alternatively, if for example it is dark outside and there is little benefit to positioning the plants towards the window, the planter frame may be rotated towards an inner portion of the room where the plants are better viewed by those in the room.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a perspective view of the planter showing the planter frame oriented towards a room and the trays in a viewing position.

FIG. 2 is a perspective view of the planter as it transitions from a viewing position to a working position.

FIG. 3 is a perspective view of the planter in a working position.

FIG. 4 is a perspective view of the planter as it is transitioned into a position towards a window.

FIG. 5 is a perspective view of the planter positioned towards a window.

FIG. 6 is a perspective view that illustrates the planter frame in a near-vertical alignment.

FIG. 7 is a perspective view that illustrates the planter pots in a working position.

FIG. 8 is a close up view of a planter tray.

FIG. 9 is a close up view of a plant pot in the planter tray.

FIG. 10 is a close up view of the connector between the base frame and the planter frame.

FIG. 11 is a close up, side view of the connector between the base frame and the planter frame and the planter tray.

FIG. 12 is a close up top view of the connector between the base frame, planter frame and planter tray.

FIG. 13 is a side perspective view of an embodiment with a wall-mounted base with a locking mechanism for locking the planter frame in position relative to the base frame.

FIG. 14 is a side perspective view of the wall-mounted embodiment.

FIG. 15 is a perspective view of an embodiment that slides within the base.

FIG. 16 is a perspective view of the slidable base embodiment with the planter trays in a different position.

FIG. 17 is a perspective view of the slidable base embodiment also showing a counterweight.

FIG. 18 is a bottom view of the slidable base embodiment.

FIG. 19 is a perspective view of an embodiment with a swivel base.

FIG. 20 is a perspective view of the swivel base embodiment with the frame in a different position.

FIG. 21 illustrates the swive device.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

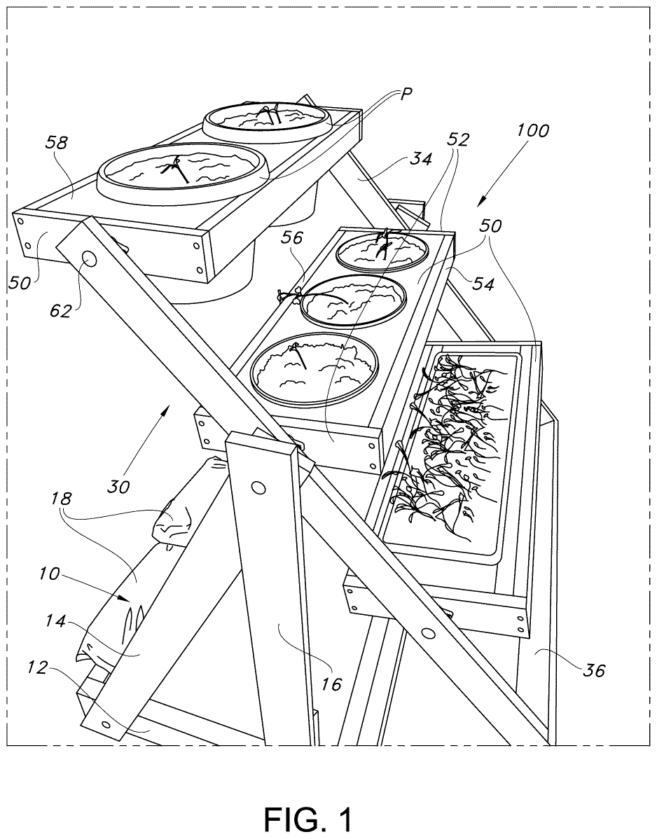

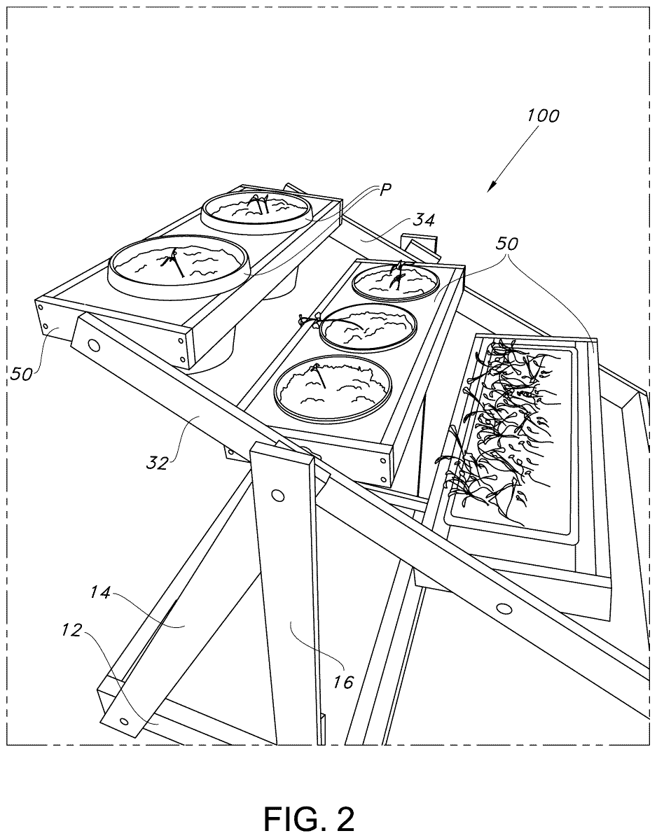

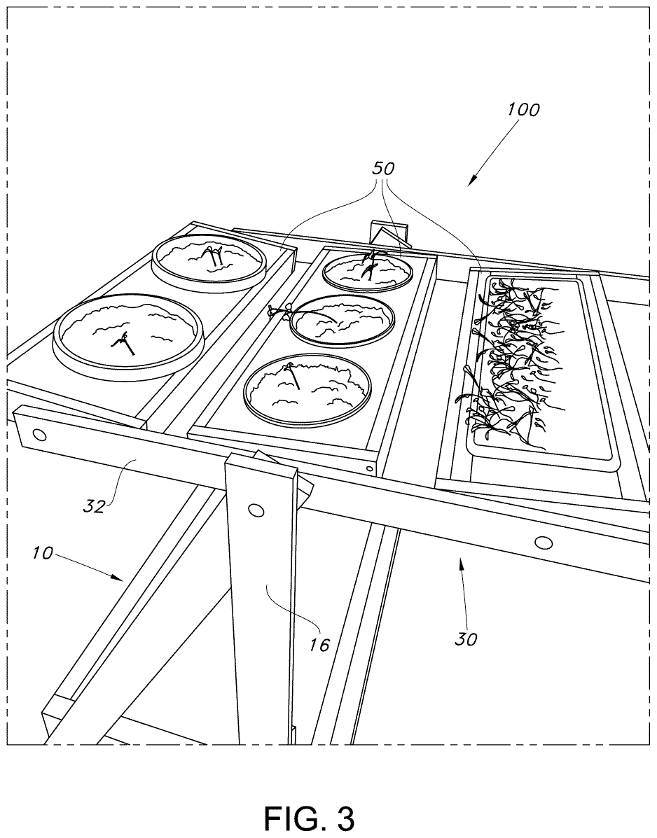

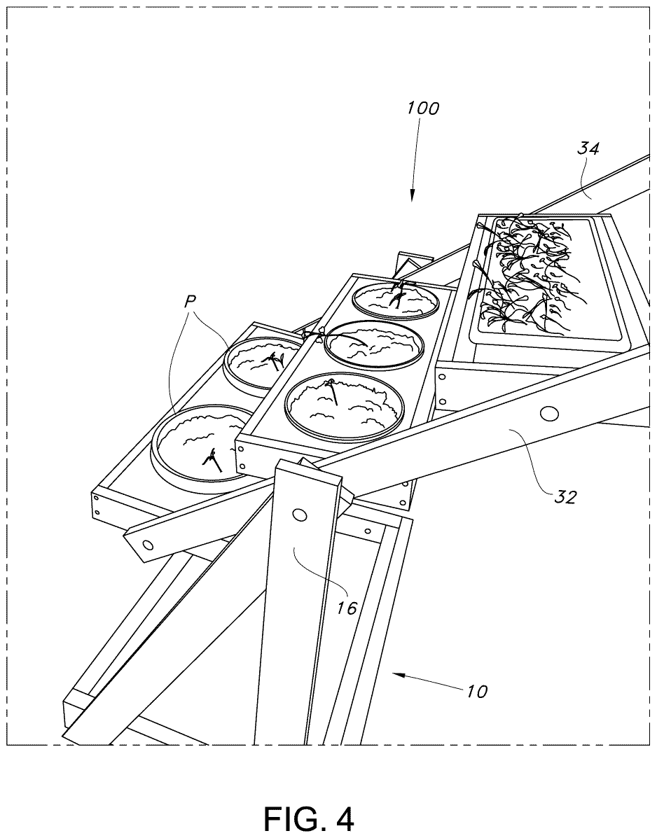

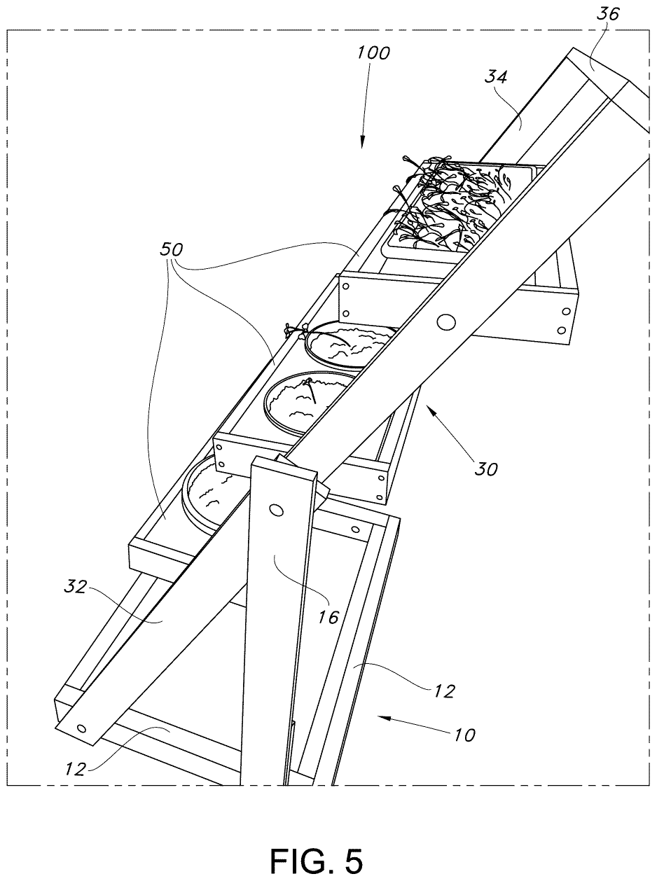

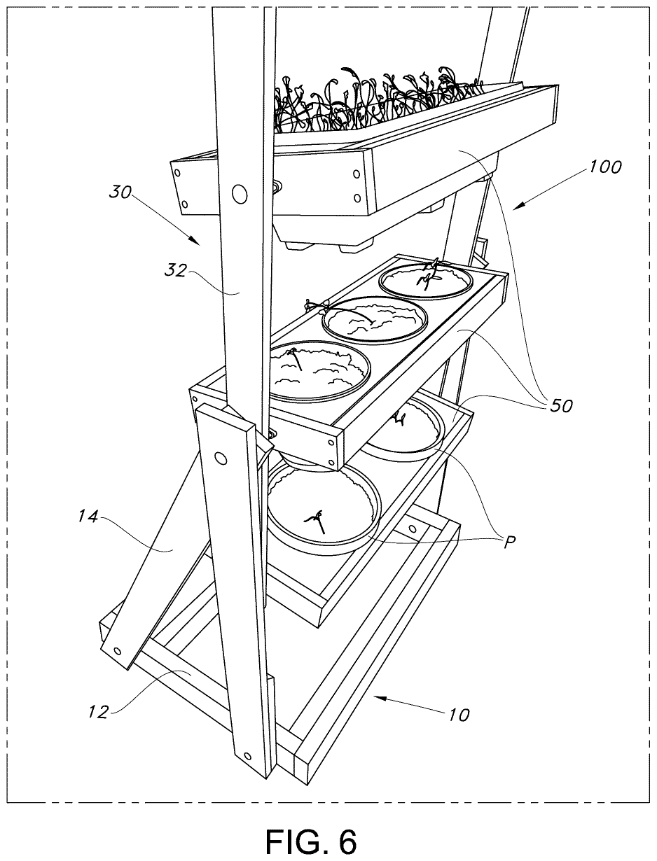

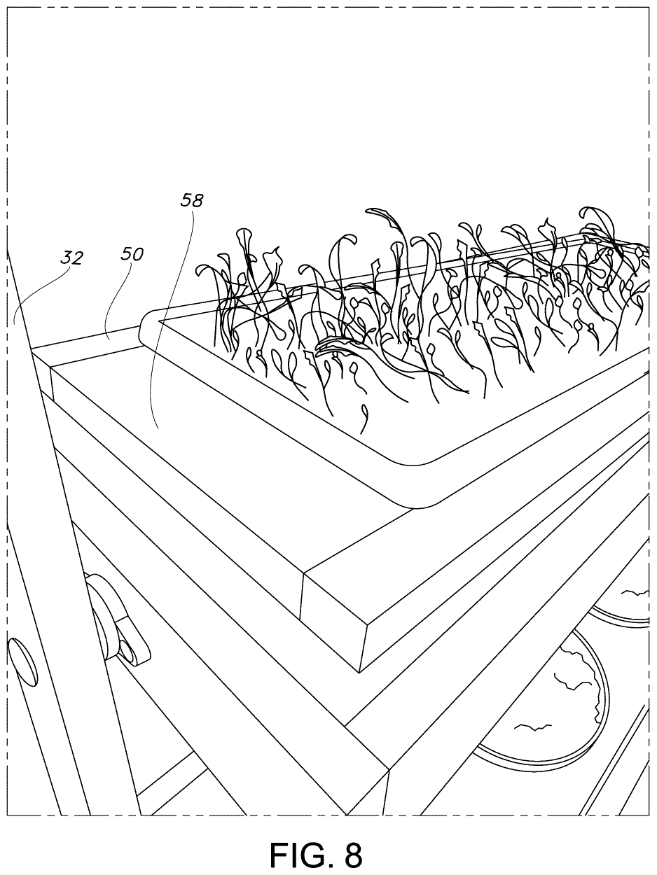

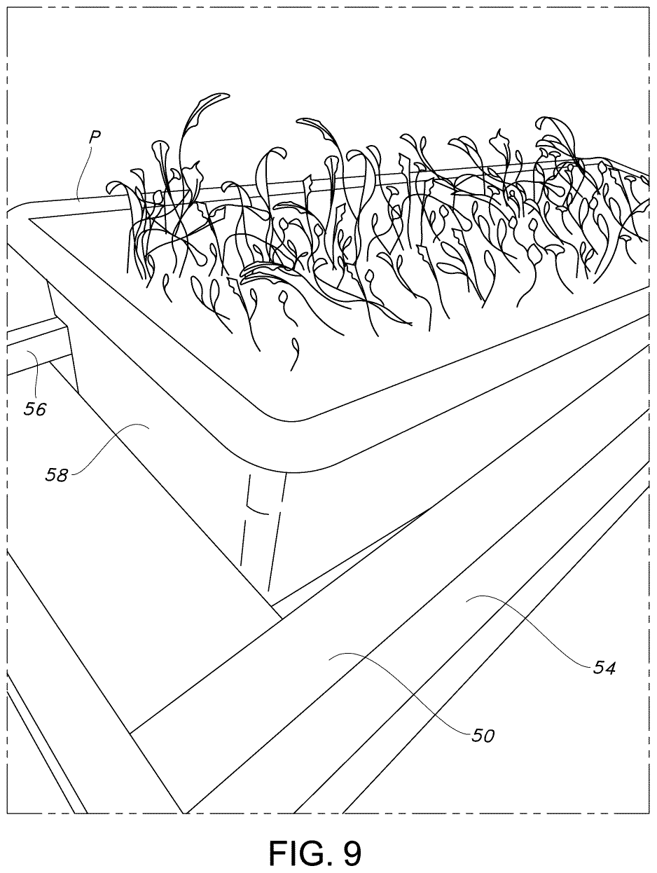

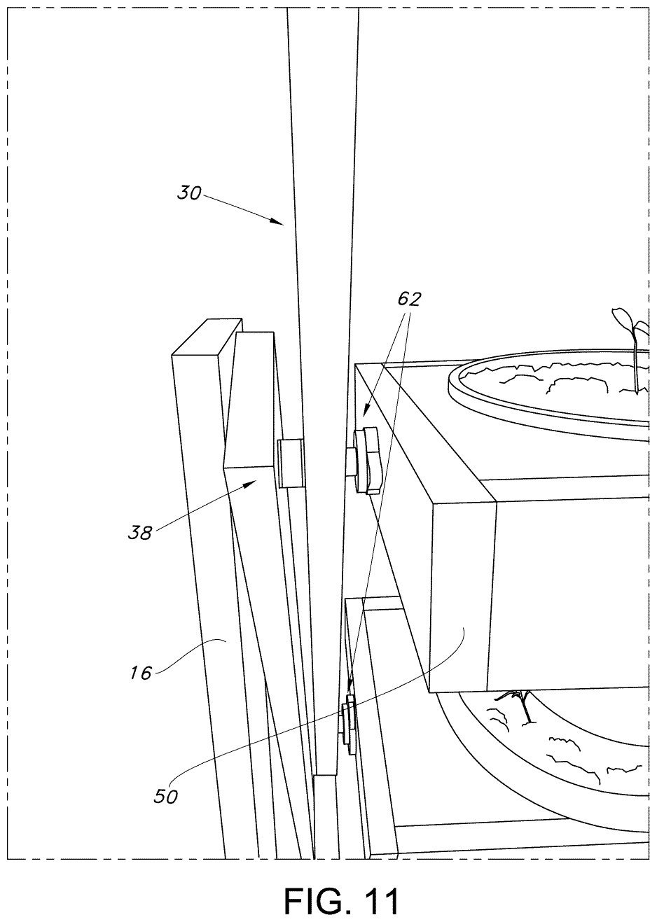

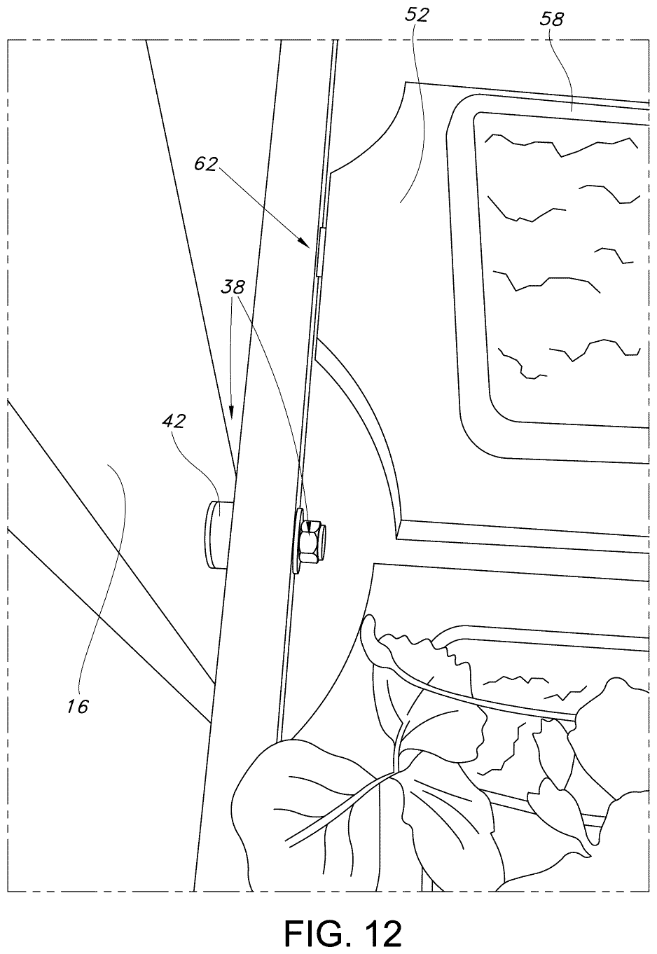

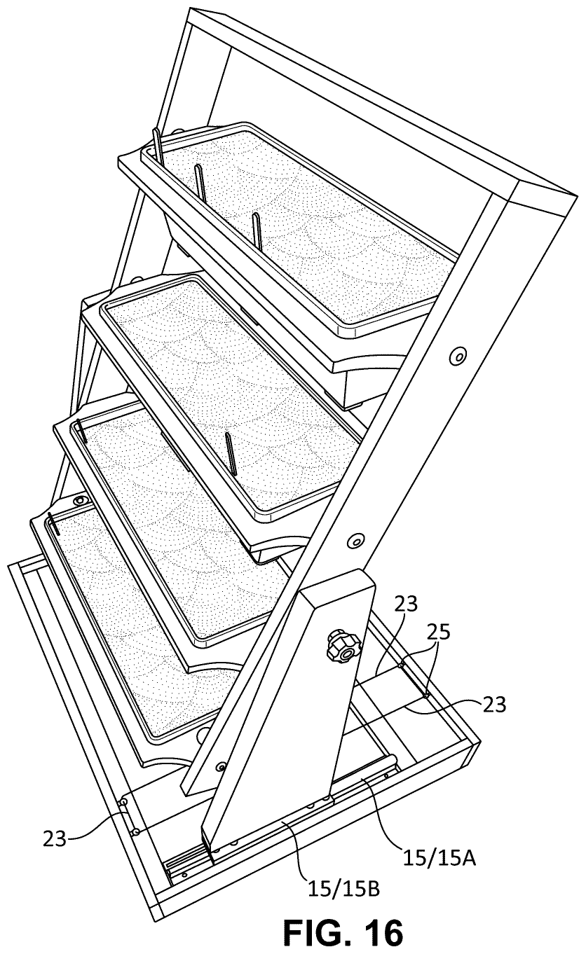

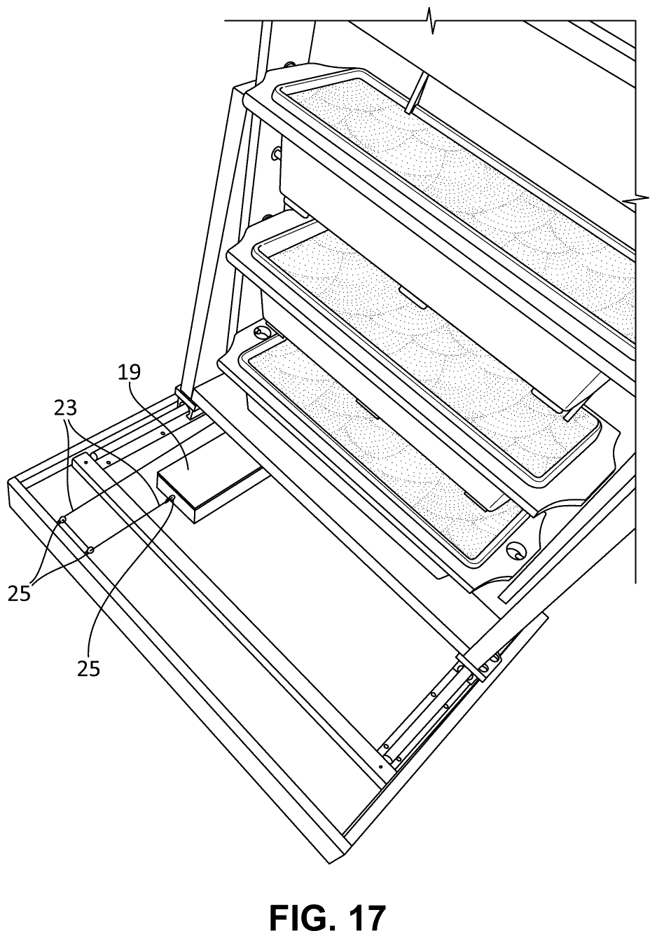

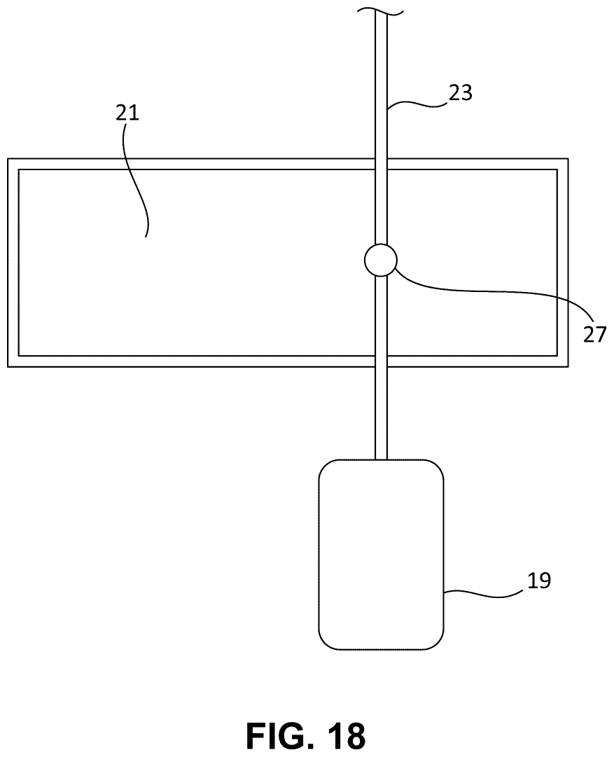

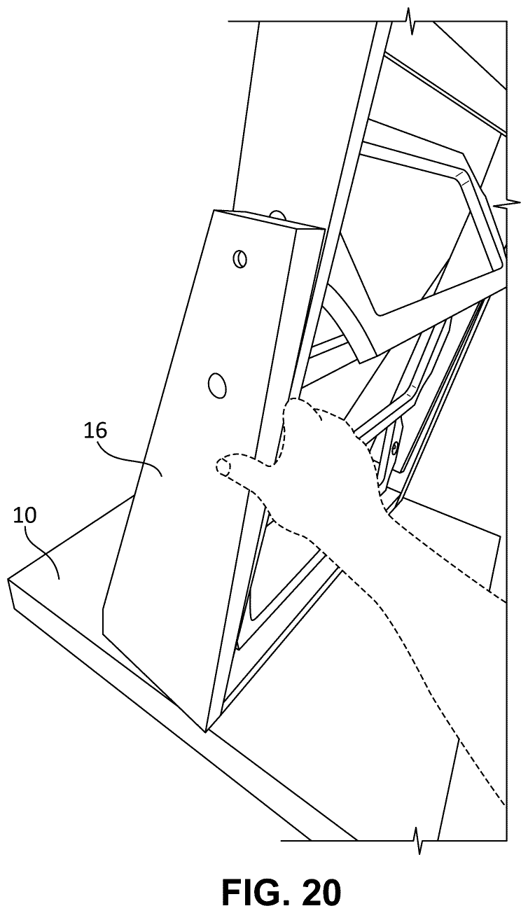

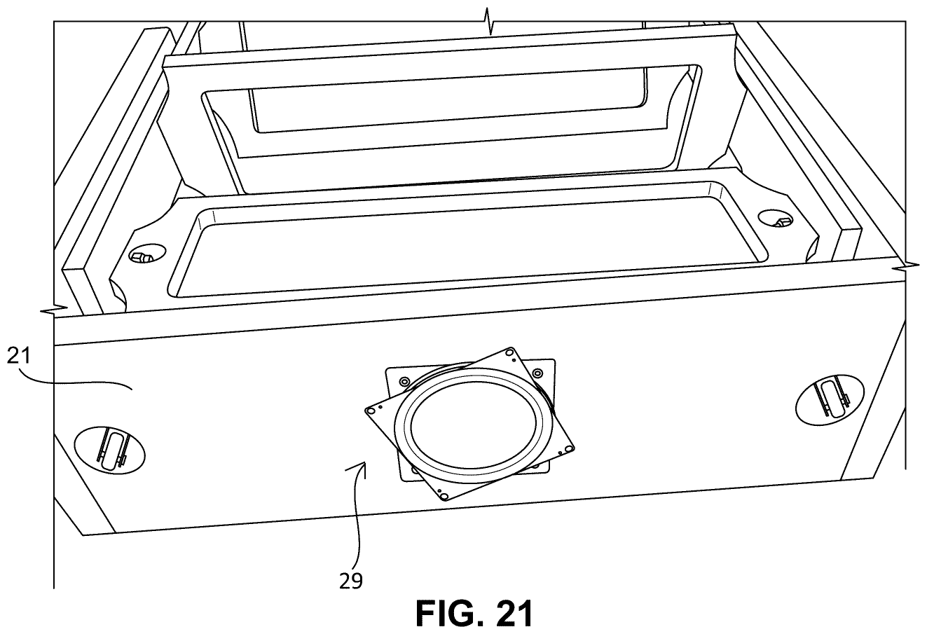

FIGS. 1-21 illustrate a rotatable plant holder 100 according to the invention, including a base frame 10 that rotatably supports a planter frame 30, and one or more planter trays 50 that are rotatably supported in the planter frame 30.

Conventional plant pots P are supportable within the planter trays 50. The planter frame 30 is configured to rotate about a fixed point within the base frame 10 so as to allow the planter frame 30 in the vertical plane. Most embodiments allow for 360 degrees of rotation. As the planter frame 30 moves within the base frame 10 the planter trays 50 also move within the planter frame 30 so as to maintain an upright or substantially upright position. Different embodiments may have varying parameters, however, in this context wherein a substantially upright position is defined as an orientation within 15 degrees of vertical. The rotatable plant holder 100 may be used inside or outside of a building structure, and certain components may have slightly different construction depending on whether the device is intended to be used inside or outside.

The base frame 10 may be configured in a number of suitable manners.

In the embodiment shown in FIGS. 1-12, there are four floor supports 12, a vertical support 16, and a cross brace 14, all of which are assembled and secured using conventional techniques and fasteners. In general, the vertical support 16 should have a height around 36 inches so that the planter frame 30 is at a convenient working height for the average user when it is placed in a horizontal position. The vertical support 16 may also be configured, using conventional techniques, to have an adjustable height so that users may choose their preferred height.

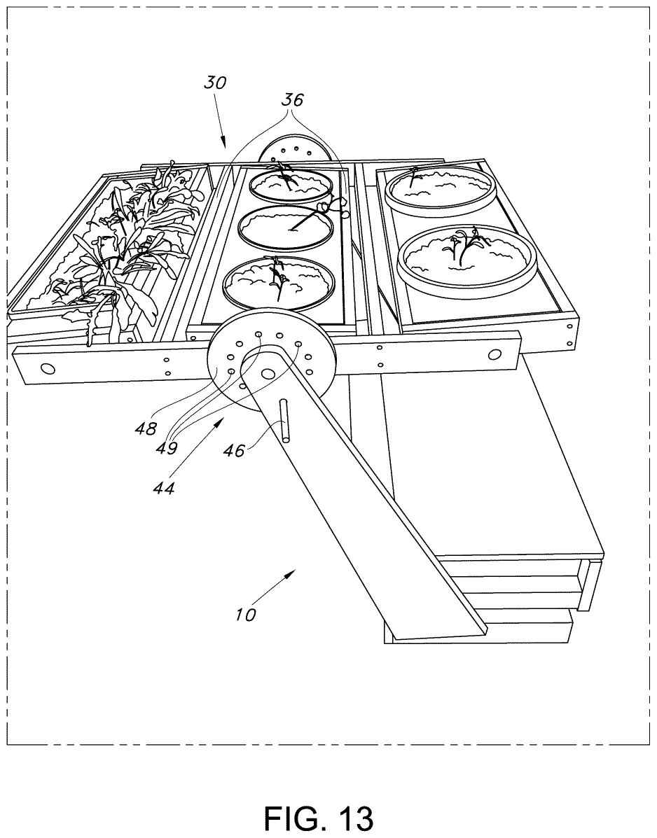

In an alternative embodiment, shown in FIGS. 13-18, the base 10 includes slidable components. More specifically, the vertical supports 16 are slidably coupled to the floor supports 12. This design allows the floor supports 12 to maintain a static position while the vertical supports 16, and as a result the planter frame 30 and planter trays 50, slide back and forth within the floor supports 12. This provides a number of benefits, for example, the floor supports may be positioned near a window which is advantageous to provide the plants in the planter trays 50 with sunlight, but, with a static base, this may not allow for enough space to transition the trays 50 into the horizontal workspace or to face the other side of the room. The slidable vertical supports allow for great freedom of movement without the need to move the entire base 10.

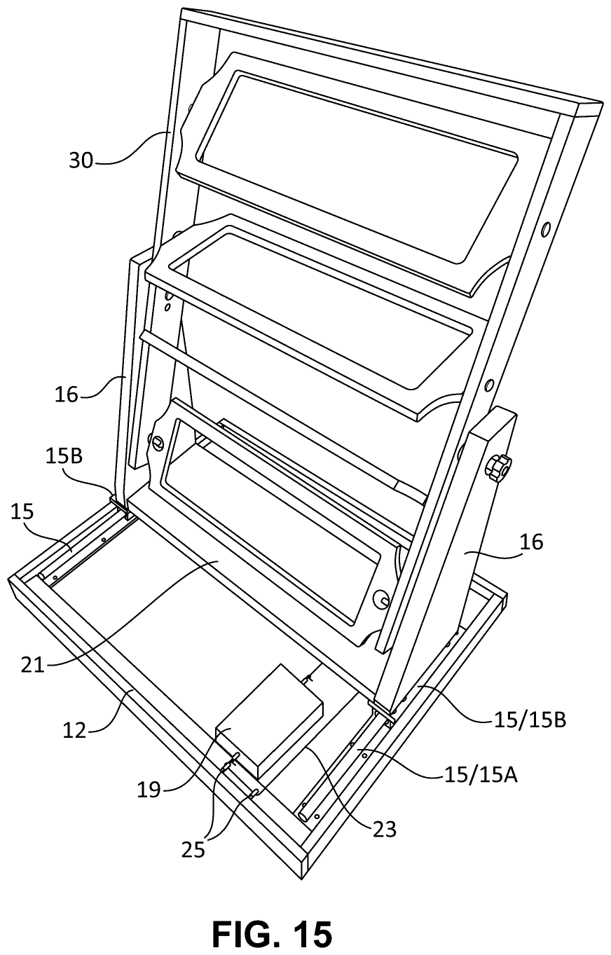

In the embodiment shown in FIGS. 15-18 the vertical supports 16 are slidably coupled to the floor supports 12 by a pair of conventional rails 15. Each floor support 12 includes an integrated rail system 15A that receives a corresponding portion 15B of the vertical support, allowing for linear adjustment along the length of the rail. This slidable engagement enables the vertical supports 16 to be repositioned laterally to accommodate different tray arrangements or spatial requirements. The rails 15 may include locking mechanisms or detents to secure the vertical supports in a desired position during use.

This embodiment also includes a counterweight 19 that ensures the device 100 is balanced and does not lean or tip over regardless of where the planter trays 50 are positioned. The counterweight is configured to slide on a floor or ground surface beneath under the other device components. A cross support 21 extends between and is coupled to the vertical supports 16. A cable 23 is coupled to either side of counterweight 19 and extends through looped fasteners 25 and is attached to a fastener 27 beneath the cross support 21. As such, as the vertical supports slide in one direction the counterweight is pulled in an opposite direction.

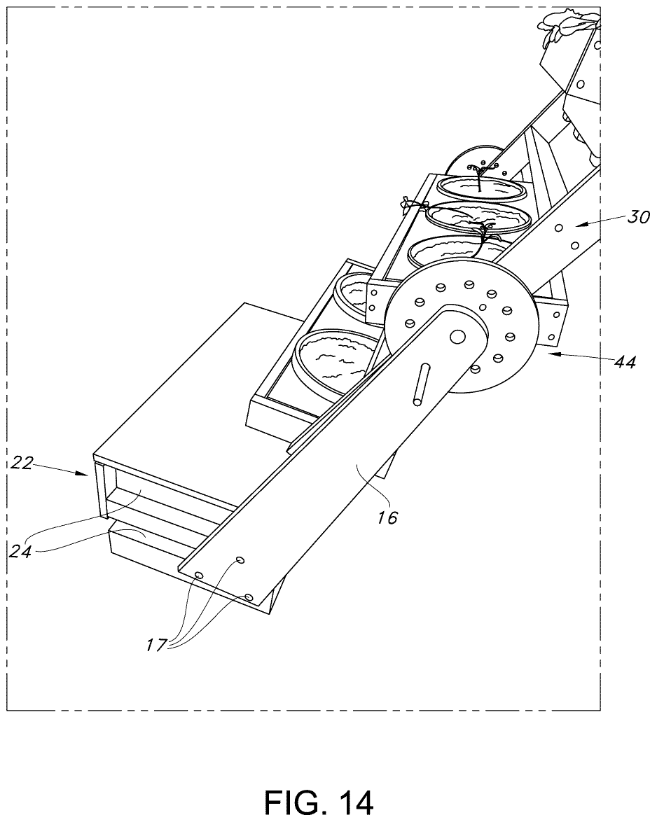

In the embodiment shown in FIGS. 13 and 14 the floor supports 12 are in the form of a mounted unit 22 that is configured to be fastened to a structural surface, such as a wall or floor surface. Here the vertical support 16 is slightly angled and secured in the mounted unit 22. In the embodiment shown, three rollers 17 are secured within two rails 24 on either side of the base are used to enable horizontal movement of the vertical support 16 so that it may slide towards or away from the wall so that the planter frame 30 may be positioned close to a window for better access to the light or, alternatively, slide away from the wall so that the planter frame may pivot to a different position within the two vertical supports 16 without contacting the structural surface, such as a wall. Other configurations are also feasible, such as those that include more or fewer rollers 17, or that have a different manner of coupling the base 10 to the frame 30. The wall mounted unit 22 may also include a drawer or be configured as an open storage area.

The slideable embodiments may also employ breaking and locking mechanisms. For example, to lock the vertical supports in a particular position in the base, a simple rod fix to the planter frame that drops into a hole in the planter base at various points along the slide may be provided. A break may be set up with curved strap mounted on the inside of the rail system, connected to the underside of the frame. It comes over the rail and when pressed down and clips into a groved fixed system that runs parallel to the rail on the outside. When locked it presses a rubber brake pad onto the rail holding planter in place.

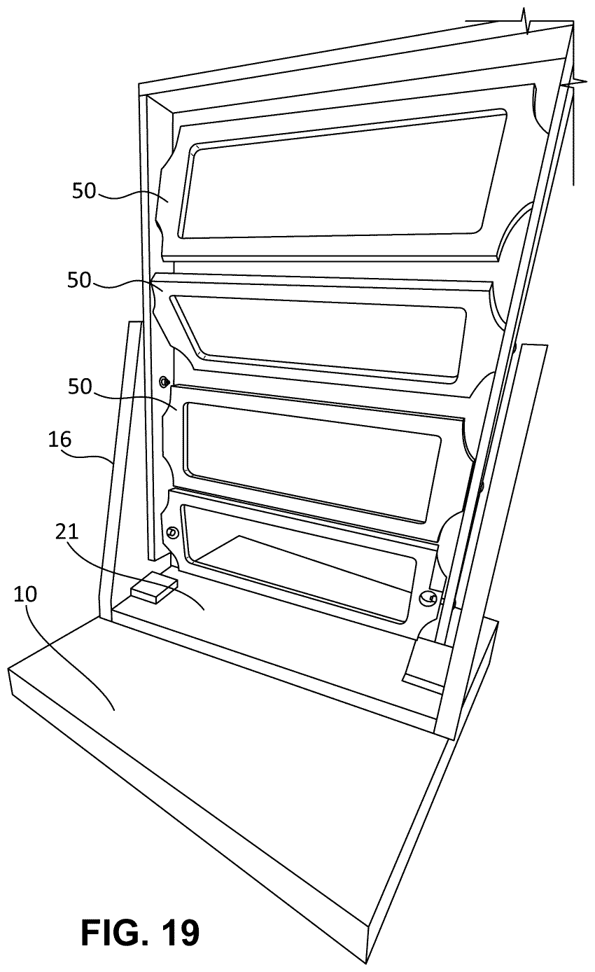

FIGS. 19-21 illustrate yet another embodiment, wherein the vertical supports 16 are affixed to the cross support 21, and the cross support 21 is rotatably coupled to the base 10 by a coupler 29. The base 10 is in the form of a platform, with a flat upper surface. The coupler 29 in the embodiment is a swivel plate, which may allow the planter frame 30 to swivel or rotate in a full 360-degree circular motion.

The planter frame 30 may similarly be configured in a number of suitable manners. In the embodiments shown, the planter frame 30 includes a first siderail 32, a second side rail 34, and one or more support rails 36, each of the first siderail 32 and second siderail 34 being connected to the support rails 36 using conventional means. The support rails 36 may be located in a number of positions, for example, in the embodiment shown in FIGS. 1-6, there is only one support rail 36 that is positioned near an end of the side rails 32, 34. Alternatively, the embodiment shown in FIGS. 13 and 14 includes two support rails 36 that are positioned between the trays 50. The side rails may also be constructed in an extendable manner to allow for additional trays 50. It is also possible to construct a planter frame that does not have support rails 36, and where instead the planter trays 50 effectively couple the side rails together to form the planter frame 30 within the base frame 10.

In general, the rotatable plant holder 100 may come in a variety of sizes, largely depending on the intended area of use as the area of use often places certain restrictions on the allowable size. One primary embodiment is intended for indoor use, where the holder 100 may at various times be positioned in a staggered position towards a window, be in a horizontal working position, or be staggered towards the inside of the room for viewing.

The embodiment illustrated in FIGS. 1-12 is ideally constructed for indoor use, and in particular to be positioned near a window so that the plants may receive sunlight during daylight hours. In this embodiment, the holder 100 may at various times be positioned in a staggered position towards a window, be in a horizontal working position, or be staggered towards the inside of the room for viewing. In this embodiment, having a vertical support 16 that measures approximately 36 inches is preferred as this creates a working surface having a height that is similar to most countertops. The overall length of the planter frame 32 is preferably sized relative to the base and the base's position relative to the wall so that the planter frame 32 may rotate freely without contacting the wall. For example, if the pivot point of the planter frame is 18 inches from the outer edge of the base frame, then the length of the planter frame is preferably less than 36 inches with no more than 18 inches on either side of the frame. This embodiment may also have a relatively narrow base to conserve floor space when the planter tray is positioned towards the window, the base 10 constructed to be position between the wall/window and the pivot point on the planter tray frame 32. A counterweight 18 may be placed on the floor support 12 that is closest to the window to ensure that the base frame 10 is able to maintain its position regardless of the position of the planter frame 30. Relatively small wheels that are sized appropriately for indoor use may be added to the base frame 10 to enable convenient movement of the device from one area to another.

Other embodiments of the base frame may have slightly different construction if, for example, it is intended for outdoor use or as a mounted unit, e.g., mounted to a wall, window, or railing. For outdoor use, positioning against or near a window is unlikely to be a concern and so the base 10 may extend the same distance on either side of the vertical support 16 and larger wheels are likely to be advantageous when moving over a ground area. The size of the base frame and plant holder frame are also not as much of a concern; however, it is still advantageous to construct the device 100 in a manner that places the plant holder frame at a reasonable height when it is in the horizontal working position so that the average user may access the plants in an ergonomic and comfortable manner.

In yet another embodiment, the size of the device may be significantly smaller such that it may be placed in, for example, a bay window. In this scenario the ability to stagger the device towards the window or towards the room serves the same purpose, but now the device may itself be placed on a table or counter when in the horizontal working position.

Each planter tray 50 is configured to hold one or more plant pots P and may be configured in a number of manners to hold pots of different shapes and sizes. FIG. 1, for example, illustrates three separate tray 50 configurations. In this embodiment, each tray 50 has two side walls 52, a front wall 54 and a rear wall 56, and a removable support platform 58. Having the removable support platform 58 allows users to customize the types, sizes, and shapes of the pots in each planter tray 50. Ideally, the pots themselves have a tapered middle section that causes the water to stay central in the pot rather than draining to one side. Additionally, have pots with an outer lip on the outside edge of the pot is beneficial so that the pot sits flat in the trays 50.

Each planter tray 50 is coupled to a swivel 62 that in turn is coupled to the planter frame 30. The swivel 62 may be as simple as a peg in an opening, or it may include a ball bearing device. While the support platform may be configured in a number of different manners, e.g., with differently sized pots in different openings/positions in the platform within the tray, it is important that the weight is approximately the same on either side of the support platform so that the tray swivels properly as the planter frame 30 is moved to different positions. For example, a support platform 58 that is configured to hold five plant pots may have one center located pot that weighs roughly 60 oz, and then two pots on one side that weigh 20 oz and 40 oz and two pots on the opposite side that also weigh 20 oz and 40 oz, respectfully. Seedling trays may be used in addition to conventional pots of varying sizes. Weights, or tilt weights, may be added to either the trays 50 and/or the pots in order to cause the tray to maintain a certain tilt, for example if a grower wants the plants to be angled in a certain manner to receive better light. A leveling slide may also be added to the trays 50, whereby a weight is attached to a slide on the underside of the tray and may be moved from the top by a lever so as to change the angle of the tray.

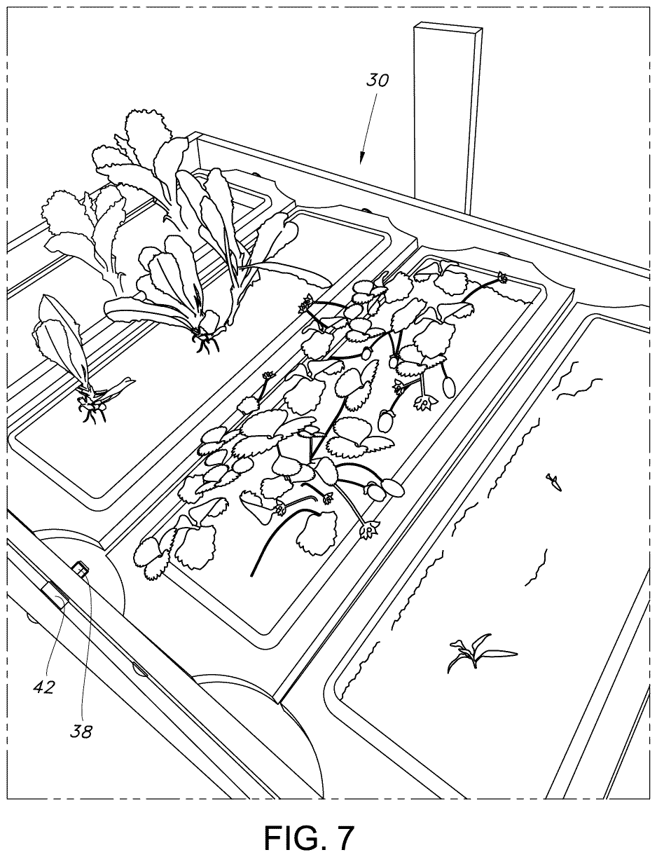

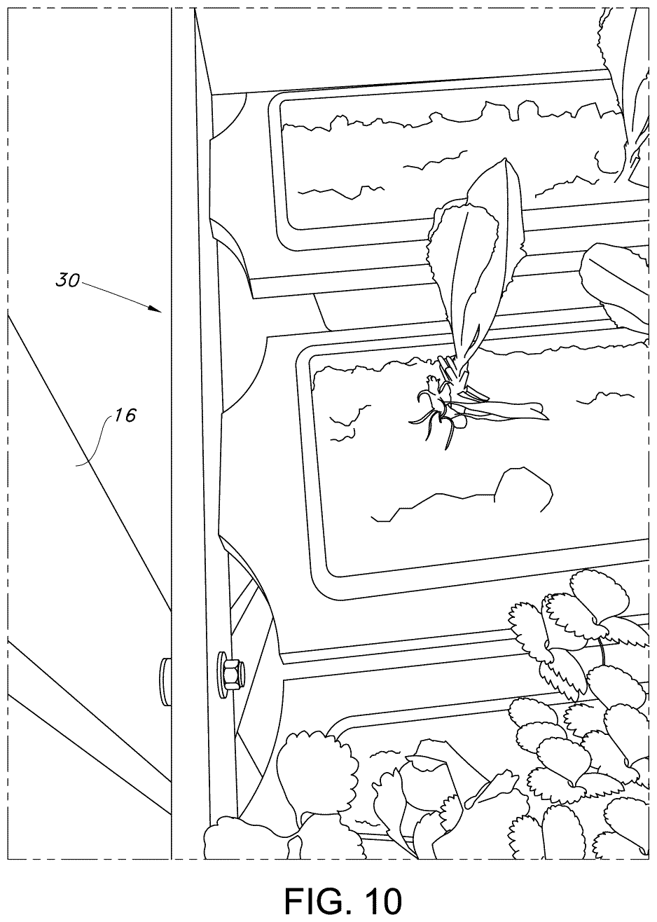

Additionally, in the embodiments shown in the drawings, the planter trays 50 act as counterweights that facilitate an easy transition from one position to another. For example, the embodiments shown in FIGS. 1-6 include three planter trays 50 with one centrally located and the other two located on either side. In this instance, the two trays 50 located on either end of the planter frame 30 counterbalance one another. The embodiment shown in FIGS. 7 and 10, for example, has two trays on either side of the pivot point, with the two trays 50 on one side counterbalancing the two trays 50 on the other side. If, for example, 100 pounds of plants are placed on one end and 100 pounds placed on the exact opposite side, the two cancel each other out so moving that 200 pounds around takes essentially zero pounds of force.

The planter frame 30 is coupled to the base frame 10 by a threaded fastener 38. For example, in the embodiment shown, the two frames are coupled to one another with a tension bolt with a spacer 42 separating the two frames to allow for better movement. The fastener 38 may be adjusted to allow more or less movement of the planter frame 30 relative to the base frame 10. In some instances, such as those shown in FIGS. 7, 10 and 12, the fastener 38 may only connect the base 10 to the frame 30, while in other instances, such as those shown in FIGS. 1-6, the fastener may also be used to secure a tray 50. A locking system 44 may also be provided. For example, as shown in FIG. 13, a locking system 44 may be in the form of spring lock 46, whereby a donut 48 having openings 49 at varying orientations may be placed around the spacer, and a spring lock may move though an opening in the support post 16 to secure the lock in the desired opening.

It is understood that the embodiments described herein are merely illustrative of the present invention. Variations in the construction of the rotatable planter may be contemplated by one skilled in the art without limiting the intended scope of the invention herein disclosed and as defined by the following claims.

What is claimed is:

1: A rotatable plant holder comprising:
a base frame and a planter frame, the planter frame rotatably coupled to the base frame and configured to rotate in a vertical plane relative to the base frame;
one or more planter trays coupled to the planter frame, each of the one or more planter trays configured to swivel within the planter frame to maintain a substantially upright position as the planter frame rotates relative to the base frame; and
wherein the base frame comprises a pair of slidable vertical supports coupled to a pair of floor supports, the slidable vertical supports enabling lateral adjustment of the planter frame.

2: The rotatable plant holder of claim 1, further comprising a counterweight that slides on a floor or ground surface beneath the other device components to ensure the device is balanced and does not lean or tip over regardless of the position of the planter trays.

3: The rotatable plant holder of claim 1, wherein the base frame comprises a mounted unit configured to be fastened to a structural surface, the mounted unit comprising:
a pair of rails secured to the structural surface;
a plurality of rollers secured within the rails; and
wherein the vertical supports are configured to engage with the rollers to enable horizontal movement of the vertical supports relative to the structural surface, thereby allowing the planter frame to be positioned at varying distances from the structural surface.

4: The rotatable plant holder of claim 3, wherein the structural surface is selected from the group consisting of a wall surface and a floor surface, and wherein the horizontal movement of the vertical supports enables the planter frame to be positioned closer to a window for improved access to sunlight or farther from the wall to facilitate pivoting of the planter frame without contacting the structural surface

5: The rotatable plant holder of claim 3, wherein the mounted unit further comprises a storage area configured as at least one of a drawer and an open

6: The rotatable plant holder of claim 1, wherein the planter frame is configured to rotate 360 degrees in the vertical plane relative to the base frame.

7: The rotatable plant holder of claim 6, wherein the planter frame may be angled towards a window to position the plants in the planter trays to receive optimal sunlight.

8: The rotatable plant holder of claim 6, wherein the planter frame may be positioned in a horizontal configuration to resemble a gardening table.

9: The rotatable plant holder of claim 6, wherein the planter frame may be rotated towards an inner portion of a room to present the plants in the planter trays for better viewing by occupants of the room.

10: The rotatable plant holder of claim 1, wherein the planter trays are configured to hold a variety of plant pots of different shapes and sizes.

11: The rotatable plant holder of claim 10, wherein the planter trays include a removable support platform to allow customization of the types, sizes, and shapes of plant pots placed in each tray.

12: The rotatable plant holder of claim 12, wherein the weight of the plant pots placed in the planter trays is balanced on either side of the support platform to facilitate proper swiveling of the trays as the planter frame is moved.

13: The rotatable plant holder of claim 1, wherein the planter frame comprises an adjustable locking mechanism configured to secure the planter frame at a desired angle relative to the base frame.

14: rotatable plant holder comprising:
a base in the form of a platform having a flat upper surface;
a planter frame comprising a first side rail, a second side rail, and at least one support rail connecting the first and second side rails;
a coupler rotatably coupling the planter frame to the base, wherein the coupler comprises a swivel plate configured to allow the planter frame to rotate in a full 360-degree circular motion relative to the base;
one or more planter trays rotatably supported in the planter frame, each planter tray configured to maintain a substantially upright position as the planter frame rotates; and.
wherein the planter frame further comprises a cross support affixed to vertical supports, the cross support being rotatably coupled to the base by the coupler.

15: The rotatable plant holder of claim 14, wherein the one or more planter trays are configured to hold conventional plant pots.

16: The rotatable plant holder of claim 14, wherein the substantially upright position is defined as an orientation within 15 degrees of vertical.

17: The rotatable plant holder of claim 14, further comprising a locking system configured to secure the planter frame at a desired orientation relative to the base.

18: The rotatable plant holder of claim 14, wherein the planter frame is coupled to the base by a threaded fastener with a spacer separating the planter frame and the base to allow for improved movement.

19: The rotatable plant holder of claim 14, wherein the planter frame may be positioned in a staggered position towards a window, in a horizontal working position, or staggered towards an inside of a room for viewing.

20: The rotatable plant holder of claim 14, wherein the planter frame is sized relative to the base to allow the planter frame to rotate freely without contacting a wall when the base is positioned adjacent to the wall.
